(19) United States
(12) Patent Application Publication
(10) Pub. No.: US 2021/0049619 A1
(43) Pub. Date: Feb. 18, 2021

(54) System, Method, and Computer Program Product for Determining a Dormancy Classification of an Account Using Deep Learning Model Architecture

(71) Applicant: Visa International Service Association, San Francisco, CA (US)

(72) Inventors: Spiridon Zarkov, Singapore (SG); Chuxin Liao, Singapore (SG); Anubhav Narang, Singapore (SG)

(21) Appl. No.: 16/540,131

(22) Filed: Aug. 14, 2019

(51) Int. Cl. G06Q 30/02; G06Q 40/02; G06N 20/00; G06N 3/04

(52) U.S. Cl. CPC G06Q 30/0201; G06N 3/0481; G06N 20/00; G06Q 40/02

(57) ABSTRACT

Provided is a computer-implemented method for determining a customer dormancy profile including receiving transaction data associated with a plurality of payment transactions conducted using an account of an account holder, generating an output of a first residual processing block based on the transaction data associated with the plurality of payment transactions, providing the output of the first residual processing block to a concatenate function block and to a second residual processing block, generating an output of the second residual processing block based on the output of the first residual processing block, generating an output of the concatenate function block based on the output of the first residual processing block and the output of the second residual processing block, and determining an account dormancy label based on the output of the concatenate function block. A system and computer program product are also provided.

### BACKGROUND

### 1. Field

This disclosure relates generally to systems, devices, products, apparatus, and methods that are used for determining a classification of an account, and in one particular embodiment, to a system, product, and method for determining an account dormancy label of an account associated with a customer using a machine learning model architecture.

### 2. Technical Considerations

Machine learning may be a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

In some instances, a machine learning model, such as a predictive machine learning model, may be used to make a prediction regarding a risk or an opportunity based on data. A predictive machine learning model may be used to analyze a relationship between the performance of a unit based on data associated with the unit and one or more known features of the unit. The objective of the predictive machine learning model may be to assess the likelihood that a similar unit will exhibit the performance of the unit. A predictive machine learning model may be used as a fraud detection model. For example, predictive machine learning models may perform calculations based on data associated with payment transactions to evaluate the risk or opportunity of a payment transaction involving a customer in order to guide a decision of whether to authorize the payment transaction.

A business (e.g., a merchant) may be classified by the type of goods or services provided by the business according to a merchant category. For example, a Merchant Category Code (MCC) (e.g., a four-digit number listed in ISO 18245 for retail financial services) may be used to classify the merchant based on the merchant category of the merchant. An MCC may be assigned based on a type of classification of the merchant (e.g., a type of classification for a hotel, a merchant category for a hotel, a type of classification for an office supply store, a merchant category for an office supply store, and/or the like) and/or by a name of the merchant (e.g., an MCC of 3000 for United Airlines).

In some examples, an MCC may be assigned to a merchant by a transaction service provider (e.g., credit card company) when the merchant first starts accepting credit cards and/or debit cards as a form of payment. Additionally or alternatively, an MCC may be used by a financial institution to determine how to provide loyalty program rewards (e.g., loyalty program points) to a customer that conducts a payment transaction involving a merchant that has the MCC.

However, a financial institution and/or a transaction service provider may be unable to accurately determine an alignment between an account (e.g., a credit card account, a debit card account, and/or the like) and a classification of the account with regard to activity of the account by a customer. For example, the financial institution and/or the transaction service provider may be unable to accurately determine whether the user will conduct a payment transaction involving the account. Accordingly, the financial institution and/or the transaction service provider may transmit offers to the customer that are ineffective at encouraging the customer to conduct a payment transaction. By transmitting offers that are ineffective, network resources and/or processing resources may be wasted as compared to transmitting a smaller number of offers that are effective.

### SUMMARY

Accordingly, disclosed are systems, devices, products, apparatus, and/or methods for determining an account dormancy label of an account associated with a customer using a machine learning model architecture.

According to a non-limiting aspect or embodiment, provided is a computer-implemented method for determining an account dormancy label of an account associated with a customer using a machine learning model architecture. The method may comprise receiving, with at least one processor, transaction data associated with a plurality of payment transactions conducted using an account of an account holder; generating, with at least one processor, an output of a first residual processing block based on the transaction data associated with the plurality of payment transactions; providing, with at least one processor, the output of the first residual processing block to a concatenate function block and to a second residual processing block; generating, with at least one processor, an output of the second residual processing block based on the output of the first residual processing block; generating, with at least one processor, an output of the concatenate function block based on the output of the first residual processing block and the output of the second residual processing block, wherein the output of the concatenate function block comprises an embedding vector; and determining, with at least one processor, an account dormancy label based on the output of the concatenate function block.

According to a non-limiting aspect or embodiment, provided is a system for determining an account dormancy label of an account associated with a customer using a machine learning model architecture, the system comprising at least one processor programmed or configured to: receive transaction data associated with a plurality of payment transactions conducted using an account of an account holder; generate an output of a first residual processing block based on the transaction data associated with the plurality of payment transactions; provide the output of the first residual processing block to a concatenate function block and to a second residual processing block; generate an output of the second residual processing block based on the output of the first residual processing block; generate an output of the concatenate function block based on the output of the first residual processing block and the output of the second residual processing block, wherein the output of the concatenate function block comprises an embedding vector; and determine an account dormancy label based on the output of the concatenate function block.

According to a non-limiting aspect or embodiment, provided is a computer program product for determining an account dormancy label of an account associated with a customer using a machine learning model architecture, the computer program product comprising at least one non-transitory computer-readable medium including one or more instructions that, when executed by at least one processor, cause the at least one processor to: receive transaction data associated with a plurality of payment transactions conducted using an account of an account holder; generate an output of a first residual processing block based on the transaction data associated with the plurality of payment transactions; provide the output of the first residual processing block to a concatenate function block and to a second residual processing block; generate an output of the second residual processing block based on the output of the first residual processing block; generate an output of the concatenate function block based on the output of the first residual processing block and the output of the second residual processing block, wherein the output of the concatenate function block comprises an embedding vector; and determine an account dormancy label based on the output of the concatenate function block.

Clause 1: A computer-implemented method for determining a customer dormancy profile comprising: receiving, with at least one processor, transaction data associated with a plurality of payment transactions conducted using an account of an account holder; generating, with at least one processor, an output of a first residual processing block based on the transaction data associated with the plurality of payment transactions; providing, with at least one processor, the output of the first residual processing block to a concatenate function block and to a second residual processing block; generating, with at least one processor, an output of the second residual processing block based on the output of the first residual processing block; generating, with at least one processor, an output of the concatenate function block based on the output of the first residual processing block and the output of the second residual processing block, wherein the output of the concatenate function block comprises an embedding vector; and determining, with at least one processor, an account dormancy label based on the output of the concatenate function block.

Clause 2: The computer-implemented method of clause 1, wherein generating the output of the first residual processing block comprises: applying a one-dimensional dilated convolution layer to the transaction data associated with the plurality of payment transactions to generate a dilated convolution layer output, wherein the one-dimensional dilated convolution layer comprises a dilation factor; applying a weight normalization function to the dilated convolution layer output to generate an output of the weight normalization function; applying a Tan h activation function to the output of the weight normalization function to generate an output of the Tan h activation function; and applying a Sigmoid activation function to the output of the weight normalization function to generate an output of the Sigmoid activation function; wherein the output of the first residual processing block is based on the output of the Tan h activation function and the output of the Sigmoid activation function.

Clause 3: The computer-implemented method of clauses 1 or 2, further comprising: generating the dilated convolution layer output based on applying a one-dimensional dilated convolution layer to the transaction data associated with the plurality of payment transactions.

Clause 4: The computer-implemented method of any of clauses 1-3, further comprising: applying a dropout function to the output of the Tan h activation function to generate a first output of the dropout function; applying the dropout function to the output of the Sigmoid activation function to generate a second output of the dropout function; applying a multiply function to the first output of the dropout function and the second output of the dropout function to generate an output of the multiply function; and applying a one-by-one convolution layer to the output of the multiply function; wherein the output of the first residual processing block comprises an output of the one-by-one convolution layer based on the output of the multiply function.

Clause 5: The computer-implemented method of any of clauses 1-4, wherein the dilation factor of the one-dimensional dilated convolution layer is equal to one.

Clause 6: The computer-implemented method of any of clauses 1-5, wherein generating the output of the second residual processing block comprises: applying a one-dimensional dilated convolution layer to the output of the first residual processing block to generate a dilated convolution layer output, wherein the one-dimensional dilated convolution layer comprises a dilation factor; applying a weight normalization function to the dilated convolution layer output to generate an output of the weight normalization function; applying a Tan h activation function to the output of the weight normalization function to generate an output of the Tan h activation function; and applying a Sigmoid activation function to the output of the weight normalization function to generate an output of the Sigmoid activation function; wherein the output of the first residual processing block is based on the output of the Tan h activation function and the output of the Sigmoid activation function.

Clause 7: The computer-implemented method of any of clauses 1-6, wherein determining the account dormancy label based on the output of the concatenate function block comprises: providing the output of the concatenate function block to one or more dense layers; generating an output of the one or more dense layers based on the output of the concatenate function block; providing the output of the one or more dense layers to a softmax activation function; generating an output of the softmax activation function; and applying the account dormancy label to the account of the account holder based on the output of the softmax activation function.

Clause 8: A system for determining a customer dormancy profile comprising: at least one processor programmed or configured to: receive transaction data associated with a plurality of payment transactions conducted using an account of an account holder; generate an output of a first residual processing block based on the transaction data associated with the plurality of payment transactions; provide the output of the first residual processing block to a concatenate function block and to a second residual processing block; generate an output of the second residual processing block based on the output of the first residual processing block; generate an output of the concatenate function block based on the output of the first residual processing block and the output of the second residual processing block, wherein the output of the concatenate function block comprises an embedding vector; and determine an account dormancy label based on the output of the concatenate function block.

Clause 9: The computer-implemented method of clause 8, wherein when generating the output of the first residual processing block, the at least one processor is programmed or configured to: apply a one-dimensional dilated convolution layer to the transaction data associated with the plurality of payment transactions to generate a dilated convolution layer output, wherein the one-dimensional dilated convolution layer comprises a dilation factor; apply a weight normalization function to the dilated convolution layer output to generate an output of the weight normalization function; apply a Tan h activation function to the output of the weight normalization function to generate an output of the Tan h activation function; and apply a Sigmoid activation function to the output of the weight normalization function to generate an output of the Sigmoid activation function; wherein the output of the first residual processing block is based on the output of the Tan h activation function and the output of the Sigmoid activation function.

Clause 10: The system of clauses 8 or 9, wherein the at least one processor is further programmed or configured to: generate the dilated convolution layer output based on applying a one-dimensional dilated convolution layer to the transaction data associated with the plurality of payment transactions.

Clause 11: The system of any of clauses 8-10, wherein the at least one processor is further programmed or configured to: apply a dropout function to the output of the Tan h activation function to generate a first output of the dropout function; apply the dropout function to the output of the Sigmoid activation function to generate a second output of the dropout function; apply a multiply function to the first output of the dropout function and the second output of the dropout function to generate an output of the multiply function; and apply a one-by-one convolution layer to the output of the multiply function; and wherein the output of the first residual processing block comprises an output of the one-by-one convolution layer based on the output of the multiply function.

Clause 12: The system of any of clauses 8-11, wherein the dilation factor of the one-dimensional dilated convolution layer is equal to one.

Clause 13: The system of any of clauses 8-12, wherein, when generating the output of the second residual processing block, the at least one processor is programmed or configured to: apply a one-dimensional dilated convolution layer to the output of the first residual processing block to generate a dilated convolution layer output, wherein the one-dimensional dilated convolution layer comprises a dilation factor; apply a weight normalization function to the dilated convolution layer output to generate an output of the weight normalization function; apply a Tan h activation function to the output of the weight normalization function to generate an output of the Tan h activation function; and apply a Sigmoid activation function to the output of the weight normalization function to generate an output of the Sigmoid activation function; wherein the output of the first residual processing block is based on the output of the Tan h activation function and the output of the Sigmoid activation function.

Clause 14: The system of any of clauses 8-13, wherein, when determining the account dormancy label based on the output of the concatenate function block, the at least one processor is programmed or configured to: provide the output of the concatenate function block to one or more dense layers; generate an output of the one or more dense layers based on the output of the concatenate function block; provide the output of the one or more dense layers to a softmax activation function; generate an output of the softmax activation function; and apply the account dormancy label to the account of the account holder based on the output of the softmax activation function.

Clause 15: A computer program product for determining a customer dormancy profile, the computer program product comprising at least one non-transitory computer-readable medium including one or more instructions that, when executed by at least one processor, cause the at least one processor to: receive transaction data associated with a plurality of payment transactions conducted using an account of an account holder; generate an output of a first residual processing block based on the transaction data associated with the plurality of payment transactions; provide the output of the first residual processing block to a concatenate function block and to a second residual processing block; generate an output of the second residual processing block based on the output of the first residual processing block; generate an output of the concatenate function block based on the output of the first residual processing block and the output of the second residual processing block, wherein the output of the concatenate function block comprises an embedding vector; and determine an account dormancy label based on the output of the concatenate function block.

Clause 16: The computer-implemented method of clause 15, wherein the one or more instructions that cause the at least one processor to generate the output of the first residual processing block cause the at least one processor to: apply a one-dimensional dilated convolution layer to the transaction data associated with the plurality of payment transactions to generate a dilated convolution layer output, wherein the one-dimensional dilated convolution layer comprises a dilation factor; apply a weight normalization function to the dilated convolution layer output to generate an output of the weight normalization function; apply a Tan h activation function to the output of the weight normalization function to generate an output of the Tan h activation function; and apply a Sigmoid activation function to the output of the weight normalization function to generate an output of the Sigmoid activation function; wherein the output of the first residual processing block is based on the output of the Tan h activation function and the output of the Sigmoid activation function.

Clause 17: The computer program product of clauses 15 or 16, wherein the one or more instructions further cause the at least one processor to: generate the dilated convolution layer output based on applying a one-dimensional dilated convolution layer to the transaction data associated with the plurality of payment transactions.

Clause 18: The computer program product any of clauses 15-17, wherein the one or more instructions further cause the at least one processor to: apply a dropout function to the output of the Tan h activation function to generate a first output of the dropout function; apply the dropout function to the output of the Sigmoid activation function to generate a second output of the dropout function; apply a multiply function to the first output of the dropout function and the second output of the dropout function to generate an output of the multiply function; and apply a one-by-one convolution layer to the output of the multiply function; wherein the output of the first residual processing block comprises an output of the one-by-one convolution layer based on the output of the multiply function.

Clause 19: The computer program product of any of clauses 15-18, wherein the dilation factor of the one-dimensional dilated convolution layer is equal to one.

Clause 20: The computer program product of any of clauses 15-19, wherein the one or more instructions that cause the at least one process to generate the output of the second residual processing block cause the at least one processor to: apply a one-dimensional dilated convolution layer to the output of the first residual processing block to generate a dilated convolution layer output, wherein the one-dimensional dilated convolution layer comprises a dilation factor; apply a weight normalization function to the dilated convolution layer output to generate an output of the weight normalization function; apply a Tan h activation function to the output of the weight normalization function to generate an output of the Tan h activation function; and apply a Sigmoid activation function to the output of the weight normalization function to generate an output of the Sigmoid activation function; wherein the output of the first residual processing block is based on the output of the Tan h activation function and the output of the Sigmoid activation function.

Clause 21: The computer program product of any of clauses 15-20, wherein the one or more instructions that cause the at least one processor to determine the account dormancy label based on the output of the concatenate function block cause the at least one processor to: provide the output of the concatenate function block to one or more dense layers; generate an output of the one or more dense layers based on the output of the concatenate function block; provide the output of the one or more dense layers to a softmax activation function; generate an output of the softmax activation function; and apply the account dormancy label to the account of the account holder based on the output of the softmax activation function.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of non-limiting embodiments or aspects are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may be implemented according to the principles of the present disclosure;

FIG. 2 is a diagram of a non-limiting aspect or embodiment of components of one or more devices and/or one or more systems of FIG. 1;

FIG. 3 is a flowchart of a non-limiting embodiment of a process for determining an account dormancy label of an account associated with a customer using a machine learning model architecture;

FIG. 4 is a diagram of a non-limiting embodiment of a machine learning model architecture for determining an account dormancy label of an account associated with a customer; and

FIGS. 5A-5E are diagrams of a non-limiting embodiment of an implementation of a process for determining an account dormancy label of an account associated with a customer using a machine learning model architecture.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “account identifier” may include one or more types of identifiers associated with an account (e.g., a PAN associated with an account, a card number associated with an account, a payment card number associated with an account, a token associated with an account, and/or the like). In some non-limiting embodiments, an issuer may provide an account identifier (e.g., a PAN, a token, and/or the like) to a user (e.g., an account holder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “token” may refer to an account identifier of an account that is used as a substitute or replacement for another account identifier, such as a PAN. Tokens may be associated with a PAN or other original account identifier in one or more data structures (e.g., one or more databases) such that they may be used to conduct a payment transaction without directly using an original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes.

As used herein, the term “merchant” may refer to one or more entities (e.g., operators of retail businesses) that provide goods, services, and/or access to goods and/or services to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more electronic devices, which may be used by a merchant to conduct a transaction (e.g., a payment transaction) and/or process a transaction. Additionally or alternatively, a POS device may include peripheral devices, card readers, scanning devices (e.g., code scanners and/or the like), Bluetooth® communication receivers, near-field communication (NFC) receivers, radio frequency identification (RFID) receivers, and/or other contactless transceivers or receivers, contact-based receivers, payment terminals, and/or the like.

As used herein, the term “POS system” may refer to one or more client devices and/or peripheral devices used by a merchant to conduct a transaction. For example, a POS system may include one or more POS devices and/or other like devices that may be used to conduct a payment transaction. In some non-limiting embodiments, a POS system (e.g., a merchant POS system) may include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. In some non-limiting embodiments, a transaction service provider may include a credit card company, a debit card company, a payment network such as Visa®, MasterCard®, AmericanExpress®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “payment device” may refer to a payment card (e.g., a credit or debit card), a gift card, a smart card (e.g., a chip card, an integrated circuit card, and/or the like), smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like).

As used herein, the term “computing device” may refer to one or more electronic devices that are configured to directly or indirectly communicate with another electronic device via one or more networks. In some non-limiting embodiments, a computing device may include a mobile device. A mobile device may include a smartphone, a portable computer, a wearable device (e.g., watches, glasses, lenses, clothing, and/or the like), a personal digital assistant (PDA), and/or other like devices. In some non-limiting embodiments, a computing device may include a server, a desktop computer, and/or the like.

As used herein, the terms “client” and “client device” may refer to one or more computing devices, such as processors, storage devices, and/or similar computer components, that access a service made available by a server. In some non-limiting embodiments, a “client device” may refer to one or more devices that facilitate payment transactions, such as one or more POS devices used by a merchant. In some non-limiting embodiments, a client device may include a computing device configured to communicate with one or more networks and/or facilitate payment transactions such as, but not limited to, one or more desktop computers, one or more mobile devices, and/or other like devices. Moreover, a “client” may also refer to an entity, such as a merchant, that owns, utilizes, and/or operates a client device for facilitating payment transactions with a transaction service provider.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or clients.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

In some non-limiting embodiments, computer-implemented methods, systems, and computer program products for determining a dormancy classification of an account associated with a customer using a machine learning model architecture are disclosed. For example, a computer-implemented method may include receiving transaction data associated with a plurality of payment transactions conducted using an account of an account holder, generating an output of a first residual processing block based on the transaction data associated with the plurality of payment transactions, providing the output of the first residual processing block to a concatenate function block and to a second residual processing block, generating an output of the second residual processing block based on the output of the first residual processing block, generating an output of the concatenate function block based on the output of the first residual processing block and the output of the second residual processing block, wherein the output of the concatenate function block may include an embedding vector, and determining an account dormancy label based on the output of the concatenate function block.

In this way, non-limiting embodiments of the present disclosure may accurately determine an alignment between an account and a classification of the account with regard to activity of the account by a customer. Accordingly, a financial institution and/or a transaction service provider may be able transmit offers to the customer that are effective at encouraging the customer to conduct a payment transaction. In this way, network resources and/or processing resources may be conserved as compared to transmitting a larger number of offers that are ineffective.

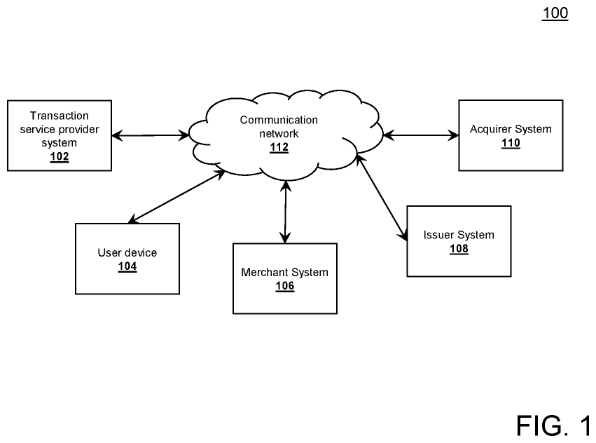

Referring now to FIG. 1, FIG. 1 is a diagram of an example environment 100 in which devices, systems, methods, and/or products described herein may be implemented. As shown in FIG. 1, environment 100 includes merchant system 106, transaction service provider system 102, acquirer system 110, issuer system 108, and user device 104. In some non-limiting embodiments, merchant system 106, transaction service provider system 102, acquirer system 110, issuer system 108, and user device 104 may interconnect (e.g., establish a connection to communicate, and/or the like) via wired connections, wireless connections, or a combination of wired and wireless connections.

Transaction service provider system 102 may include one or more devices capable of being in communication with merchant system 106, acquirer system 110, issuer system 108 and/or user device 104 via communication network 112. For example, transaction service provider system 102 may include a server (e.g., a transaction processing server), a group of servers (e.g., a group of transaction processing servers), and/or other like devices. In some non-limiting embodiments, transaction service provider system 102 may be associated with a transaction service provider as described herein.

User device 104 may include one or more devices capable of being in communication with merchant system 106, transaction service provider system 102, acquirer system 110, and/or issuer system 108 via communication network 112. For example, user device 104 may include one or more computing devices, such as one or more mobile devices, one or more smartphones, one or more wearable devices, one or more servers, and/or the like. In some non-limiting embodiments, user device 104 may communicate via a short-range wireless communication connection. In some non-limiting embodiments, user device 104 may be associated with a customer as described herein.

Merchant system 106 may include one or more devices capable of being in communication with transaction service provider system 102, acquirer system 110, issuer system 108, and user device 104 via communication network 112. For example, merchant system 106 may include one or more payment devices, one or more computing devices, such as one or more mobile devices, one or more smartphones, one or more wearable devices (e.g., watches, glasses, lenses, clothing, and/or the like), one or more PDAs, one or more servers, and/or the like. In some non-limiting embodiments, merchant system 106 may communicate via a short-range wireless communication connection (e.g., a wireless communication connection for communicating information in a range between 2 to 3 centimeters to 5 to 6 meters, such as an NFC communication connection, an RFID communication connection, a Bluetooth® communication connection, and/or the like). In some non-limiting embodiments, merchant system 106 may be associated with a merchant, as described herein.

Issuer system 108 may include one or more devices capable of being in communication with merchant system 106, transaction service provider system 102, acquirer system 110, and/or user device 104 via communication network 112. For example, issuer system 108 may include one or more computing devices, such one or more servers and/or other like devices. In some non-limiting embodiments, issuer system 108 may be associated with an issuer institution that issued a payment account and/or instrument (e.g., a credit account, a debit account, a credit card, a debit card, and/or the like) to a customer.

Acquirer system 110 may include one or more devices capable of being in communication with merchant system 106, transaction service provider system 102, issuer system 108, and/or user device 104 via communication network 112. For example, acquirer system 110 may include one or more computing devices, such one or more servers and/or other like devices. In some non-limiting embodiments, acquirer system 110 may be associated with an acquirer as described herein.

Communication network 112 may include one or more wired and/or wireless networks. For example, communication network 112 may include a cellular network (e.g., a long-term evolution (LTE) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices) of environment 100 may perform one or more functions described as being performed by another set of systems or another set of devices of environment 100.

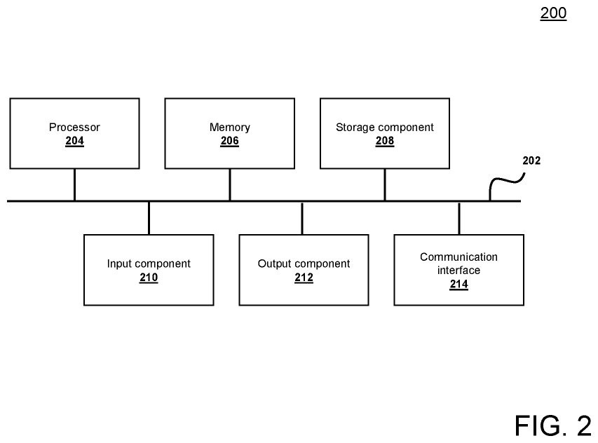

Referring now to FIG. 2, illustrated is a diagram of example components of device 200. Device 200 may correspond to one or more devices of transaction service provider system 102, one or more devices of merchant system 106 (e.g., one or more devices of a device of merchant system 106), one or more devices of acquirer system 110, one or more devices of issuer system 108, and/or one or more devices of user device 104. In some non-limiting aspects or embodiments, one or more devices of transaction service provider system 102, one or more devices of merchant system 106, one or more devices of acquirer system 110, one or more devices of issuer system 108, and/or one or more devices of user device 104 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting aspects or embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like) that can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, and/or the like). Additionally or alternatively, input component 210 may include a sensor for sensing information (e.g., a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a separate receiver and transmitter, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a WiFi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, and/or the like). Device 200 may be capable of retrieving information from, storing information in, or searching information stored in the data storage or one or more data structures in memory 206 and/or storage component 208. For example, the information may include encryption data, input data, output data, transaction data, account data, or any combination thereof.

The number and arrangement of components shown in FIG. 2 are provided as an example. In some non-limiting aspects or embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

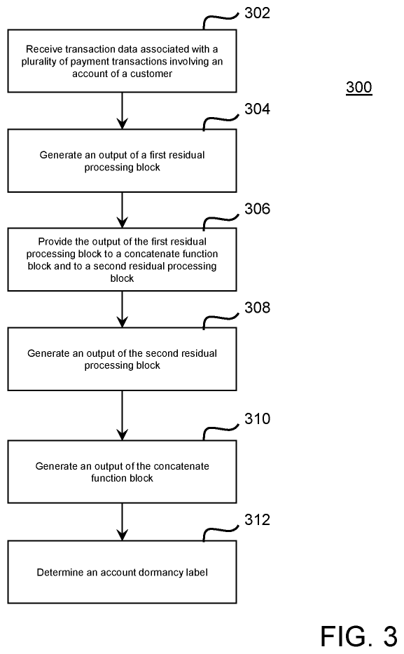

Referring now to FIG. 3, illustrated is a flowchart of a non-limiting embodiment of a process 300 for determining a dormancy classification of an account associated with a customer using a machine learning model architecture. In some non-limiting aspects or embodiments, one or more of the functions described with respect to process 300 may be performed (e.g., completely, partially, and/or the like) by transaction service provider system 102. In some non-limiting embodiments, one or more of the steps of process 300 may be performed (e.g., completely, partially, and/or the like) by another device or a group of devices separate from and/or including transaction service provider system 102 such as, for example, user device 104, merchant system 106, issuer system 108, and/or acquirer system 110.

As shown in FIG. 3, at step 302, process 300 may include receiving, with at least one processor, transaction data associated with a plurality of payment transactions involving an account of a customer. For example, transaction service provider system 102 may receive transaction data associated with a plurality of payment transactions involving the account (e.g., a debit account, a credit account, a debit card account, a credit card account, and/or the like) of the customer (e.g., a user associated with user device 104). In some non-limiting embodiments, transaction service provider system 102 may receive the transaction data from merchant system 106, acquirer system 110, issuer system 108, and/or user device 104 (e.g., via network 112). For example, transaction service provider system 102 may receive the transaction data from merchant system 106 via network 112 in real-time while a payment transaction is being conducted, after a payment transaction has been authorized, after a payment transaction has been cleared, and/or after a payment transaction has been settled. Transaction service provider system 102 may receive transaction data (e.g., historical transaction data, first transaction data, first historical transaction data, and/or the like) associated with a plurality of payment transactions involving (e.g., conducted by) a user, a plurality of users, and/or the like. In some non-limiting embodiments, the payment transaction data may be associated with a plurality of payment transactions involving one or more accounts of a customer, a plurality of accounts of a plurality of customers, and/or the like. In some non-limiting embodiments, the payment transaction data may include historical payment transaction data associated with one or more payment transactions that have been authorized, cleared, and/or settled.

In some non-limiting embodiments, transaction service provider system 102 may receive transaction data associated with a plurality of payment transactions conducted during a time interval (e.g., a plurality of payment transactions conducted within an hour, a plurality of payment transactions conducted within a day, a plurality of payment transactions conducted within a week, and/or the like) involving an account of a customer. For example, transaction service provider system 102 may receive the transaction data associated with the plurality of payment transactions conducted during a predetermined time interval involving the account of the user.

In some non-limiting embodiments, the payment transaction data may be associated with a payment transaction (e.g., a payment transaction of a plurality of payment transactions) and/or a plurality of payment transactions. For example, the transaction data may be associated with a payment transaction involving a user and a merchant (e.g., a merchant associated with merchant system 106). In some non-limiting embodiments, the plurality of payment transactions may involve a plurality of users and a plurality of merchants and each payment transaction of the plurality of payment transactions may involve a single user and a single merchant.

In some non-limiting embodiments, the transaction data associated with a payment transaction may include transaction amount data associated with an amount of the payment transaction (e.g., a cost associated with the payment transaction, a transaction amount, an overall transaction amount, a cost of one or more products involved in the payment transaction, and/or the like), transaction time data associated with a time interval at which the payment transaction occurred (e.g., a time of day, a day of the week, a day of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like), transaction type data associated with a transaction type of the payment transaction (e.g., an online transaction, a card present transaction, a face-to-face transaction, and/or the like), and/or the like.

Additionally or alternatively, the transaction data may include user transaction data associated with the user involved in the payment transaction, merchant transaction data associated with the merchant involved in the payment transaction, and/or issuer institution transaction data associated with an issuer institution of an account involved in the payment transaction. In some embodiments, user transaction data may include user identity data associated with an identity of the customer (e.g., a unique identifier of the customer, a name of the customer, and/or the like), user account data associated with an account of the customer (e.g., an account identifier associated with the customer, a PAN associated with a credit and/or debit account of the customer, a token associated with a credit and/or debit account of the user, and/or the like), and/or the like.

In some embodiments, merchant transaction data may include merchant identity data associated with an identity of the merchant (e.g., a unique identifier of the merchant, a name of the merchant, and/or the like), merchant category data associated with at least one merchant category of the merchant (e.g., a code for a merchant category, a name of a merchant category, a type of a merchant category, and/or the like), merchant account data associated with an account of the merchant (e.g., an account identifier associated with an account of the merchant, a PAN associated with an account of the merchant, a token associated with an account of the merchant, and/or the like), and/or the like.

In some embodiments, issuer institution transaction data may include issuer institution identity data associated with the issuer institution that issued an account involved in the payment transaction (e.g., a unique identifier of the issuer institution, a name of the issuer institution, an issuer identification number (IIN) associated with the issuer institution, a BIN associated with the issuer institution, and/or the like), and/or the like.

In some non-limiting embodiments, transaction data associated with a payment transaction (e.g., each payment transaction of a plurality of payment transactions) may identify a merchant category of a merchant involved in the payment transaction. For example, transaction data associated with the payment transaction may include merchant transaction data that identifies a merchant category of a merchant involved in the payment transaction. A merchant category may be information that is used to classify the merchant based on the type of goods or services the merchant provides. In some non-limiting embodiments, a payment transaction may involve a merchant that is associated with a merchant category of a plurality of merchant categories.

In some non-limiting embodiments, transaction data associated with a payment transaction may identify a time (e.g., a time of day, a day, a week, a month, a year, and/or the like) at which the payment transaction occurred. For example, the transaction data associated with the payment transaction may include transaction time data that identifies a time interval at which the payment transaction occurred.

In some non-limiting embodiments, the transaction data associated with a plurality of payment transactions may include a feature vector with a plurality of features. In some non-limiting embodiments, the plurality of features may include a feature associated with a country of the customer, a feature associated with a time interval (e.g., a date, a time of day, and/or the like) of a payment transaction, a feature associated with a merchant category code (MCC) of a merchant involved in a payment transaction, a feature associated with a country code of a merchant involved in a payment transaction, a feature associated with an identifier of a merchant (e.g., a merchant dba identifier), a feature associated with merchant group code of a merchant involved in a payment transaction, a feature associated with a market segment of a merchant involved in a payment transaction, a feature associated with a transaction amount (e.g., in U.S. dollars) of a payment transaction, a feature associated with a channel of commerce (e.g., an e-commerce channel, an in-person commerce channel, and/or the like) of a payment transaction, a feature associated with an indicator of whether a payment transaction is a domestic transaction or an international transaction.

In some non-limiting embodiments, the transaction data may include an account dormancy label for an account (e.g., a classification of an amount of activity associated with an account) associated with a plurality of transactions involving the account. For example, the transaction data may include a first account dormancy label associated with a plurality of transactions, where the first account dormancy label includes an indication of an active state of an account of a customer (e.g., a stable or increasing composite ranking of an average number of transactions and an average transaction amount of a plurality of transactions in the following two quarters from a base month) involved in the plurality of transactions. Additionally or alternatively, the transaction data may include a second account dormancy label associated with a plurality of transactions, where the second account dormancy label includes an indication of a pre-dormancy state of an account of a customer (e.g., a composite ranking of an average number of transactions and an average transaction amount of a plurality of transactions in a base quarter and a cumulative decrease in the composite ranking of the average number of transactions and the average transaction amount of the plurality of transactions in following two quarters) involved in the plurality of transactions. Additionally or alternatively, the transaction data may include a third account dormancy label associated with a plurality of transactions, where the third account dormancy label includes an indication of a dormancy state of an account of a customer (e.g., a ranking of an active customer, based on a predetermined number of transactions, in a base quarter followed by no transactions in the following two quarters) involved in the plurality of transactions.

As shown in FIG. 3, at step 304, process 300 may include generating an output of a first residual processing block. For example, transaction service provider system 102 may generate the output of the first residual processing block based on the transaction data associated with the plurality of payment transactions.

In some non-limiting embodiments, transaction service provider system 102 may apply a one-dimensional (1D) dilated convolution layer to the transaction data associated with the plurality of payment transactions to generate an output of the 1D dilated convolution layer output (e.g., a dilated convolution layer output). For example, during a training process to train the first residual processing block, transaction service provider system 102 may apply a 1D dilated convolution layer to the transaction data associated with the plurality of payment transactions to generate an output of the 1D dilated convolution layer (e.g., a dilated convolution layer output). In some non-limiting embodiments, the 1D dilated convolution layer may include a time dilation factor. The time dilation factor may be a value of 0, 1, 2², 2⁴, and/or the like. The time dilation factor may be associated with a way in which a filter of the 1D dilated convolution layer is applied to (e.g., scanned over) a feature vector. For example, during a training process, as the filter of the 1D dilated convolution layer is scanned over features of a feature vector, if the time dilation factor is 0, then the filter will scan over each feature of the feature vector in order. If the time dilation factor is 1, then the filter will scan over a first feature of the feature vector and then skip over one feature, a second feature, of the feature vector and then scan a third feature of the feature vector. If the time dilation factor is 2², then the filter will scan every fourth feature of the feature vector. If the time dilation factor is 2⁴, then the filter will scan every eighth feature of the feature vector.

In some non-limiting embodiments, transaction service provider system 102 may apply a weight normalization function to the dilated convolution layer output to generate an output of the weight normalization function. For example, during a training process, transaction service provider system 102 may generate an output of a weight normalization function applying the weight normalization function to the dilated convolution layer output. In some non-limiting embodiments, transaction service provider system 102 may apply an activation function (e.g., a Sigmoid activation function, a hyperbolic tangent (Tan h) activation function, and/or the like) to the output of the weight normalization function to generate an output of the activation function. For example, during a training process, transaction service provider system 102 may apply an activation function to the output of the weight normalization function to generate an output of the activation function. In some non-limiting embodiments, transaction service provider system 102 may apply a first activation function (e.g., a Sigmoid activation function) to the output of the weight normalization function to generate an output of the first activation function, and transaction service provider system 102 may apply a second activation function (e.g., a Tan h activation function) to the output of the weight normalization function to generate an output of the second activation function. The first activation function and the second activation function may be the same or different.

In some non-limiting embodiments, transaction service provider system 102 may apply a dropout function to the output of the first activation function and/or the output of the second activation function. For example, during a training process, transaction service provider system 102 may apply a first dropout function to the output of the first activation function and a second dropout function to the output of the second activation function. The first dropout function and the second dropout function may be the same or different. In some non-limiting embodiments, a dropout function may include a regularization technique that prevents overfitting in a neural network (e.g., a neural network of the first residual processing block). In some non-limiting embodiments, the dropout function may remove hidden and/or visible nodes in the neural network.

In some non-limiting embodiments, transaction service provider system 102 may apply a multiply function to the output of the dropout function. For example, during a training process, transaction service provider system 102 may apply the multiply function to the output of a first dropout function and the output of a second dropout function. In some non-limiting embodiments, the multiply function may include a vector multiplication function (e.g., a function that obtains a vector dot product).

In some non-limiting embodiments, transaction service provider system 102 may apply a one-by-one (e.g., a 1×1) convolution layer to the output of the multiply function. For example, during a training process, transaction service provider system 102 may apply a 1×1 convolution layer to the output of the multiply function to generate an output of the first residual processing block. The output of the first residual processing block may include an account dormancy label of the account of the customer assigned to a plurality of transactions involving the account of the customer, where the plurality of transactions is associated with a feature vector (e.g., a feature vector based on the transaction data associated with the plurality of transactions) that was used as an input to the 1D dilated convolution layer of the first residual processing block. In some non-limiting embodiments, the output of the first residual processing block is based on the output of the first activation function and the output of the second activation function.

As shown in FIG. 3, at step 306, process 300 may include providing the output of the first residual processing block to a concatenate function block and to a second residual processing block. For example, during a training process, transaction service provider system 102 may provide the output of the first residual processing block to a concatenate function block and to a second residual processing block. In some non-limiting embodiments, functions of the second residual processing block are the same or similar to the first residual processing block. For example, the second residual processing block may include a 1D dilated convolution layer, one or more weight normalization functions, one or more activation functions, one or more dropout functions, one or more multiply functions, and/or a 1×1 convolution layer. In some non-limiting embodiments, the 1D dilated convolution layer of the second residual processing block may include a time dilation factor. The time dilation factor may be a value of 0, 1, 2², 2⁴, and/or the like.

In some non-limiting embodiments, the output of the first residual processing block may include an account dormancy label of the account of the customer for the transaction data associated with the plurality of payment transactions (e.g., a feature vector based on the transaction data associated with the plurality of transactions) that was provided as the input to the first residual processing block. In some non-limiting embodiments, transaction service provider system 102 may provide the output of the first residual processing block to the second residual processing block as the account dormancy label of the account of the customer assigned to the transaction data associated with the plurality of payment transactions that is provided as an input to the second residual processing block.

As shown in FIG. 3, at step 308, process 300 may include generating an output of the second residual processing block. For example, during a training process, transaction service provider system 102 may generate an output of the second residual processing block based on the output of the first residual processing block, the transaction data associated with the plurality of payment transactions, and/or the time dilation factor of the 1D dilated convolution layer of the second residual processing block. In some non-limiting embodiments, transaction service provider system 102 may provide the transaction data associated with the plurality of payment transactions and the output of the first residual processing block as an input to the second residual processing block.

In some non-limiting embodiments, transaction service provider system 102 may generate an output of the second residual processing block based on transaction data associated with a plurality of payment transactions conducted using an account of a customer in the same or similar fashion as described above regarding generating the output of the first residual processing block.

As shown in FIG. 3, at step 310, process 300 may include generating an output of the concatenate function block. In some non-limiting embodiments, during a training process, transaction service provider system 102 may generate the output of the concatenate function block based on the output of the first residual processing block and the output of the second residual processing block. In some non-limiting embodiments, the output of the concatenate function block may include an embedding vector associated with the output of the first residual processing block and the output of the second residual processing block. For example, the output of the concatenate function block may include an embedding vector that includes the output of the first residual processing block (e.g., a first account dormancy label of the account of the customer assigned to the transaction data associated with the plurality of payment transactions that was provided as an input to the first residual processing block) and the output of the second residual processing block (e.g., a first account dormancy label of the account of the customer assigned to the transaction data associated with the plurality of payment transactions that was provided as an input to the second residual processing block) concatenated together.

As shown in FIG. 3, at step 312, process 300 may include determining an account dormancy label. For example, during a training process, transaction service provider system 102 may determine the account dormancy label of the account of the customer. In some non-limiting embodiments, transaction service provider system 102 may determine the account dormancy label based on the output of the concatenate function block. For example, transaction service provider system 102 may provide the output of the concatenate function block as an input to a hidden layer. In some non-limiting embodiments, the hidden layer may be a dense layer of a neural network. The dense layer may include a plurality of nodes (e.g., 512, 256, 32, 16, and/or the like) associated with a size of the embedding vector (e.g., a size of the embedding vector is equal to a number of residual processing blocks) that is the output of the concatenate function block. In such an example, transaction service provider system 102 may provide an output of the hidden layer as an input to an activation function that provides a probability associated with one or more account dormancy labels (e.g., 0, 1, 2) for the account of the customer. For example, the activation function may include a softmax function and transaction service provider system 102 may provide the output of the hidden layer as an input to the softmax layer. The softmax layer may provide an output that includes probabilities associated with each of three account dormancy labels for the account of the customer. In some non-limiting embodiments, the three account dormancy labels may be associated with a first account dormancy label that includes an indication of an active state of the account of the customer, a second account dormancy label that includes an indication of a pre-dormancy state of the account of the customer, and a third account dormancy label that includes an indication of a dormancy state of the account of the customer.

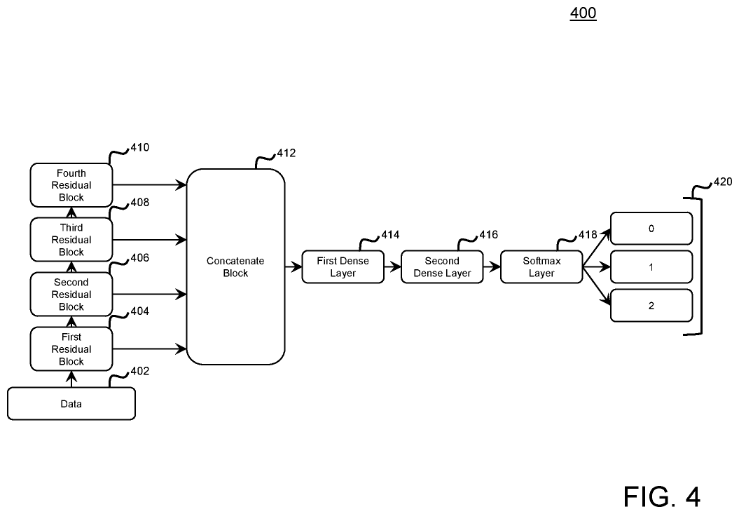

Referring now to FIG. 4, illustrated is a non-limiting embodiment of an example machine learning model architecture 400 for implementing a process (e.g., process 300) for determining a dormancy classification of an account associated with a customer. As shown in FIG. 4, machine learning model architecture 400 includes data 402, first residual processing block 404, second residual processing block 406, third residual processing block 408, fourth residual processing block 410, concatenate function block 412, first dense layer 414 (e.g., 512 node dense layer), second dense layer 416 (e.g., 256 node dense layer), softmax layer 418, and softmax layer output 420. In some non-limiting embodiments, machine learning model architecture 400 may be included in transaction service provider system 102. First residual processing block 404, second residual processing block 406, third residual processing block 408, and/or fourth residual processing block 410 may include a weight normalization function block associated with a weight normalization function as described herein, a Sigmoid activation function associated with a Sigmoid activation function as described herein, a Tan h activation function associated with a Tan h activation function as described herein, a dropout function associated with a dropout function as described herein, a multiply function associated with a multiply function as described herein, and/or a 1×1 convolution layer associated with a 1×1 convolution function as described herein. In some non-limiting embodiments, first residual processing block 404 may be associated with a time dilation factor equal to 0. For example, a 1D dilated convolution layer of first residual processing block 404 may have a time dilation factor equal to 0.

With continued reference to FIG. 4, data 402 may include transaction data associated with a plurality of transactions. For example, data 402 may include a feature vector associated with the plurality of transactions (e.g., a feature vector including values for 11 features for each transaction of the plurality of transactions). In some non-limiting embodiments, first residual processing block 404 is configured to receive data 402 as an input. In some non-limiting embodiments, first residual processing block 404 may be configured to provide an output to second residual processing block 406 and/or to concatenate function block 412 based on data 402. For example, first residual processing block 404 may be configured to provide an output of first residual processing block 404 to second residual processing block 406.

In some non-limiting embodiments, second residual processing block 406 may be configured to receive the output from first residual processing block 404 and second residual processing block 406 may be configured to provide an output to third residual processing block 408 and/or to concatenate function block 412 based on the output of second residual processing block 406. Second residual processing block 406 may include a weight normalization function, as described herein, a Sigmoid activation function, as described herein, a Tan h activation function, as described herein, a dropout function, as described herein, a multiply function, as described herein, and/or a 1×1 convolution layer, as described herein. In some non-limiting embodiments, second residual processing block 406 may be associated with a time dilation factor equal to 1. For example, a 1D dilated convolution layer of second residual processing block 406 may have a time dilation factor equal to 1.

In some non-limiting embodiments, third residual processing block 408 may be configured to receive an output from second residual processing block 406. For example, third residual processing block 408 may be configured to receive the output from second residual processing block 406 and, third residual processing block 408 may be configured to provide an output to fourth residual processing block 410 and/or to concatenate function block 412 based on the output of third residual processing block 408. The third residual processing block 408 may include a weight normalization function (e.g., a weight normalization function as described herein), a Sigmoid activation function (e.g., a Sigmoid activation function as described herein), a Tan h activation function (e.g., a Tan h activation function as described herein), a dropout function (e.g., a dropout function as described herein), a multiply function (e.g., a multiply function as described herein), and/or a 1×1 convolution layer (e.g., a 1×1 convolution layer as described herein). In some non-limiting embodiments, third residual processing block 408 may be associated with a time dilation factor equal to 2². For example, a 1D dilated convolution layer of third residual processing block 408 may have a time dilation factor equal to 4.

In some non-limiting embodiments, fourth residual processing block 410 may receive an output from third residual processing block 408. For example, fourth residual processing block 410 may receive the output from third residual processing block 408 and fourth residual processing block 410 may provide an output to concatenate function block 412 based on the output of third residual processing block 408. The fourth residual processing block 410 may include a weight normalization function (e.g., a weight normalization function as described herein), a Sigmoid activation function (e.g., a Sigmoid activation function as described herein), a Tan h activation function (e.g., a Tan h activation function as described herein), a dropout function (e.g., a dropout function as described herein), a multiply function (e.g., a multiply function as described herein), and/or a 1×1 convolution layer (e.g., a 1×1 convolution layer as described herein). In some non-limiting embodiments, fourth residual processing block 410 may be associated with a time dilation factor equal to 2³. For example, a 1D dilated convolution layer of fourth residual processing block 410 may have a time dilation factor equal to 8.

In some non-limiting embodiments, concatenate function block 412 may be configured to receive an output from first residual processing block 404, an output from second residual processing block 406, an output from third residual processing block 408, and/or an output from fourth residual processing block 410. Concatenate function block 412 may be configured to provide an output (e.g., an embedding layer) to first dense layer 414 based on the output from first residual processing block 404, the output from second residual processing block 406, the output from third residual processing block 408, and/or the output from fourth residual processing block 410. In some non-limiting embodiments, concatenate function block 412 may be configured to perform a concatenate function as described herein.

In some non-limiting embodiments, first dense layer 414 may be configured to receive an output from concatenate function block 412. For example, first dense layer 414 may be configured to receive an output from concatenate function block 412 and first dense layer 414 may be configured to provide an output to second dense layer 416 based on the output of the concatenate function block 412. In some non-limiting embodiments, first dense layer 414 may include 512 nodes that receive the output from concatenate function block 412. For example, first dense layer 414 may include 512 nodes that are configured to receive the output from concatenate function block 412 and, based on receiving the output from concatenate function block 412, provide an output to second dense layer 416.

In some non-limiting embodiments, second dense layer 416 may be configured to receive an output from first dense layer 414. For example, second dense layer 416 may be configured to receive an output from first dense layer 414 and second dense layer 416 may be configured to provide an output to softmax layer 418 based on the output of first dense layer 414. In some non-limiting embodiments, first dense layer 414 may include one or more nodes that receive the output from one or more nodes of the first dense layer 414. For example, second dense layer 416 may include 256 nodes that are configured to receive the output from concatenate function block 412 and, based on receiving the output from concatenate function block 412, to provide an output to softmax layer 418. In some non-limiting embodiments, first dense layer 414 and second dense layer 416 may be fully connected.

In some non-limiting embodiments, softmax layer 418 may be configured to receive an output from 256 node second dense layer 416. For example, softmax layer 418 may be configured to receive an output from second dense layer 416 and softmax layer 418 may be configured to provide softmax layer output 420 based on the output of second dense layer 416. In some non-limiting embodiments, softmax layer 418 may include a softmax function (e.g., a softmax function as described herein).

In some non-limiting embodiments, softmax layer output 420 may include an account dormancy label of an account of the customer (e.g., a first account dormancy label that includes an indication of an active state of the account of the customer, a second account dormancy label that includes an indication of a pre-dormancy state of the account of the customer, or a third account dormancy label that includes an indication of a dormancy state of the account of the customer). In some non-limiting embodiments, softmax layer output 420 may include data associated with an account dormancy label as described herein.

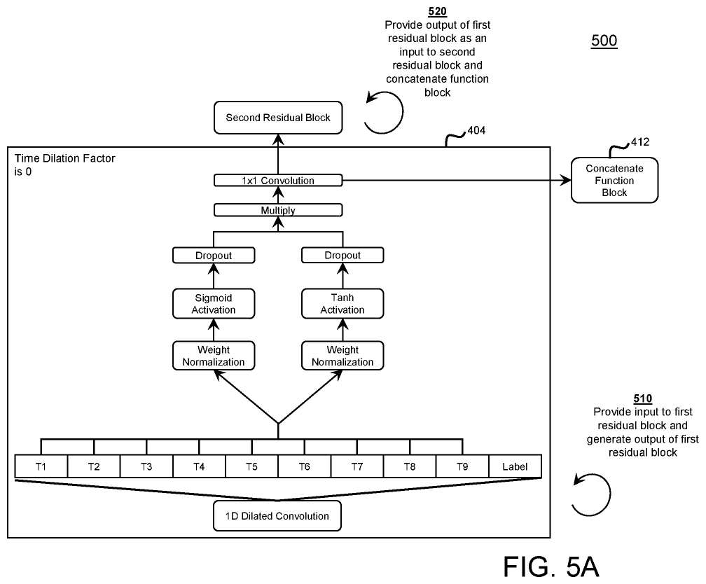

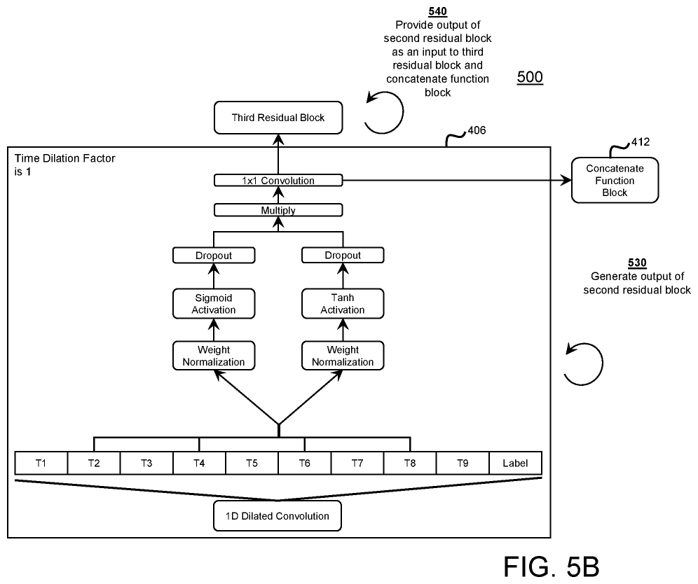

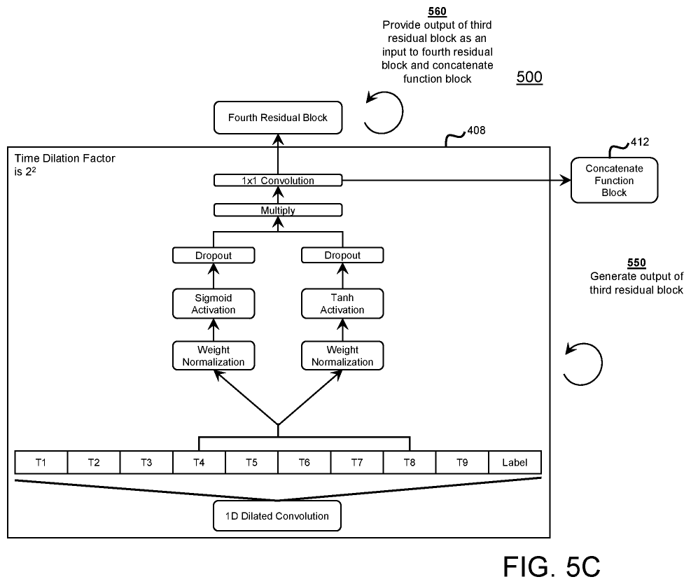

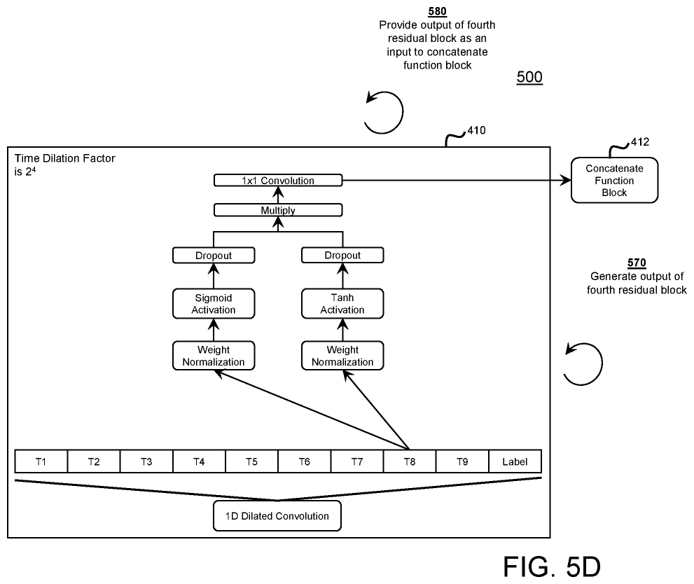

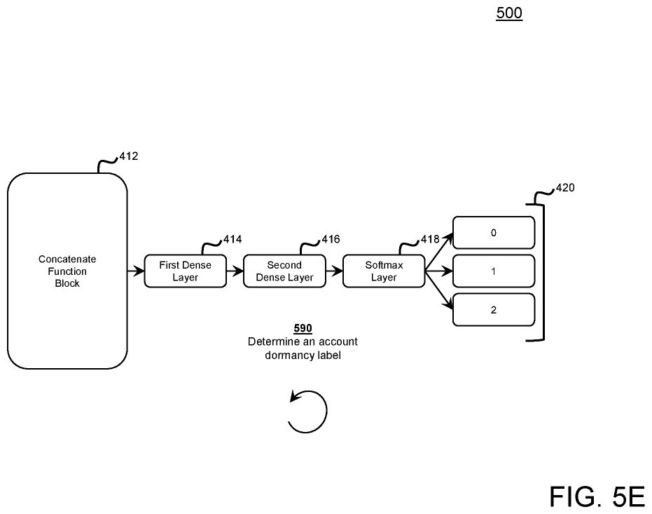

Referring now to FIGS. 5A-5E, illustrated is a diagram of an implementation 500 of a process (e.g., process 300) for determining a dormancy classification of an account associated with a customer using a machine learning architecture. As illustrated in FIGS. 5A-5E, implementation 500 may include transaction service provider system 102 performing the steps of a process (e.g., a process that is the same or similar to process 300) using machine learning architecture 400. In some non-limiting embodiments, the steps of the process shown in FIGS. 5A-5E may be associated with a training process for the machine learning model architecture. For example, the steps may be conducted during the training process for the machine learning model architecture.

As shown by reference number 510 in FIG. 5A, transaction service provider system 102 may provide an input to first residual processing block 404. For example, transaction service provider system 102 may receive transaction data associated with a plurality of transactions and transaction service provider system 102 may generate a feature vector associated with the plurality of transactions. As shown in FIG. 5A, the feature vector may include an array of values associated with a plurality of transactions T1-T9. Each position of the array may include a plurality of features associated with each of the plurality of transactions T1-T9. The plurality of features may include a feature associated with a country of the customer, a feature associated with a time interval (e.g., a date, a time of day, and/or the like) of a payment transaction, a feature associated with an MCC of a merchant involved in a payment transaction, a feature associated with a country code of a merchant involved in a payment transaction, a feature associated with an identifier of a merchant (e.g., a merchant dba identifier), a feature associated with a merchant group code of a merchant involved in a payment transaction, a feature associated with a market segment of a merchant involved in a payment transaction, a feature associated with a transaction amount (e.g., in U.S. dollars) of a payment transaction, a feature associated with channel of commerce (e.g., an e-commerce channel, an in-person commerce channel, and/or the like) of a payment transaction, or a feature associated with an indicator of whether a payment transaction is a domestic transaction or an international transaction. Transaction service provider system 102 may provide the feature vector as an input to first residual processing block 404.

As shown by reference number 510 in FIG. 5A, transaction service provider system 102 may generate an output of first residual processing block 404. For example, transaction service provider system 102 may provide the feature vector as input to a 1D dilated convolution layer with a time dilation factor equal to 0 and transaction service provider system 102 may generate an output of the 1D dilated convolution layer. Transaction service provider system 102 may scan a filter of the 1D dilated convolution layer over all of the positions of the array of the feature vector. For example, transaction service provider system 102 may scan the filter of the 1D dilated convolution layer over the plurality of features associated with each of the plurality of transactions T1-T9. In some non-limiting embodiments, transaction service provider system 102 may apply a weight normalization function to the output of the 1D dilated convolution layer. For example, transaction service provider system 102 may apply the weight normalization function to the output of the 1D dilated convolution layer to transform one or more values of the output of the 1D dilated convolution layer into a value that is within a predetermined range (e.g., a range between 0 and 1, a range between −1 and 1, and/or the like). In some non-limiting embodiments, transaction service provider system 102 may apply a Sigmoid activation function to an output of the weight normalization function. For example, transaction service provider system 102 may apply the Sigmoid activation function to the output of the weight normalization function to transform one or more values of the output of the weight normalization function to a value between 0 and 1. In some non-limiting embodiments, transaction service provider system 102 may determine an output of the Sigmoid activation function based on providing the output of the weight normalization function to the Sigmoid activation function.

In some non-limiting embodiments, transaction service provider system 102 may apply a Tan h function to the output of the weight normalization function. For example, transaction service provider system 102 may apply the Tan h activation function to the output of the weight normalization function to transform one or more values of the output of the weight normalization function to a value between −1 and 1. In some non-limiting embodiments, transaction service provider system 102 may determine an output of the Tan h activation function based on providing the output of the weight normalization function to the Tan h activation function.

In some non-limiting embodiments, transaction service provider system 102 may apply a dropout function to an output of a Sigmoid activation function. For example, transaction service provider system 102 may apply the dropout function to the output of the Sigmoid activation function to transform one or more values of the output of the Sigmoid activation function. In some non-limiting embodiments, transaction service provider system 102 may determine an output of the dropout function based on providing the output of the Sigmoid activation function to the dropout function.

In some non-limiting embodiments, transaction service provider system 102 may apply a multiply function to an output of one or more dropout functions. For example, transaction service provider system 102 may apply the multiply function to an output of a dropout function that was generated based on the output from the Sigmoid activation function and the output of the dropout function that was generated based on the output from the Tan h activation function. In some non-limiting embodiments, transaction service provider system 102 may determine an output of the multiply function based on providing the output of the Sigmoid activation function and the output of a dropout function that was generated based on the output of the Tan h activation function to the multiply function.

In some non-limiting embodiments, transaction service provider system 102 may provide the output of the multiply function as an input to a 1×1 convolution layer. For example, transaction service provider system 102 may provide the output of the multiply function as the input to a 1×1 convolution layer to determine an output of the 1×1 convolution layer. In some non-limiting embodiments, the output of the 1×1 convolution layer may include an account dormancy label for the transaction (e.g., a label indicating that the account involved in the transaction is in an account in a normal state, an account in a pre-dormancy state, and/or an account in a dormancy state).

As shown by reference number 520 in FIG. 5A, transaction service provider system 102 may provide the output of first residual processing block 404 as an input to second residual processing block 406 and concatenate function block 412. In some non-limiting embodiments, transaction service provider system 102 may provide an output of a 1×1 convolution layer as input to a concatenate function. For example, transaction service provider system 102 may provide an output of a 1×1 convolution layer as input to concatenate function block 412 to determine an output of the concatenate function. In some non-limiting embodiments, the output of the 1×1 convolution layer may include an account dormancy label of the account of the customer (e.g., a first account dormancy label that includes an indication of an active state of the account of the customer, a second account dormancy label that includes an indication of a pre-dormancy state of the account of the customer, or a third account dormancy label that includes an indication of a dormancy state of the account of the customer).

As shown by reference number 530 in FIG. 5B, transaction service provider system 102 may generate an output of second residual processing block 406. For example, transaction service provider system 102 may provide an input to second residual processing block 406. As shown in FIG. 5B, the input to second residual processing block 406 may include a feature vector and the feature vector may include an array of values associated with the plurality of transactions T1-T9 and the output of first residual processing block 404 (e.g., a label that is an account dormancy label included in the output of first residual processing block 404). The feature vector may be the same feature vector as the feature vector provided as the input to first residual processing block 404. Transaction service provider system 102 may provide the feature vector as an input to first residual processing block 404. For example, transaction service provider system 102 may provide the feature vector as input to a 1D dilated convolution layer with a time dilation factor equal to 1 and transaction service provider system 102 may generate an output of the 1D dilated convolution layer. Transaction service provider system 102 may scan a filter of the 1D dilated convolution layer over the positions of the array of the feature vector based on the time dilation factor. For example, transaction service provider system 102 may scan the filter of the 1D dilated convolution layer over the plurality of features associated with transactions T2, T4, T6, and T8, while skipping the plurality of features associated with transactions T1, T3, T5, T7, and T9. In some non-limiting embodiments, transaction service provider system 102 may apply a weight normalization function to the output of the 1D dilated convolution layer. For example, transaction service provider system 102 may apply the weight normalization function to the output of the 1D dilated convolution layer to transform one or more values of the output of the 1D dilated convolution layer into a value that is within a predetermined range (e.g., a range between 0 and 1, a range between −1 and 1, and/or the like). In some non-limiting embodiments, transaction service provider system 102 may apply a Sigmoid activation function to an output of the weight normalization function. For example, transaction service provider system 102 may apply the Sigmoid activation function to the output of the weight normalization function to transform one or more values of the output of the weight normalization function to a value between 0 and 1. In some non-limiting embodiments, transaction service provider system 102 may determine an output of the Sigmoid activation function based on providing the output of the weight normalization function to the Sigmoid activation function.

In some non-limiting embodiments, transaction service provider system 102 may apply a Tan h function to the output of the weight normalization function. For example, transaction service provider system 102 may apply the Tan h activation function to the output of the weight normalization function to transform one or more values of the output of the weight normalization function to a value between −1 and 1. In some non-limiting embodiments, transaction service provider system 102 may determine an output of the Tan h activation function based on providing the output of the weight normalization function to the Tan h activation function.

In some non-limiting embodiments, transaction service provider system 102 may apply a dropout function to an output of a Sigmoid activation function. For example, transaction service provider system 102 may apply the dropout function to the output of the Sigmoid activation function to transform one or more values of the output of the Sigmoid activation function. In some non-limiting embodiments, transaction service provider system 102 may determine an output of the dropout function based on providing the output of the Sigmoid activation function to the dropout function.

In some non-limiting embodiments, transaction service provider system 102 may apply a multiply function to an output of one or more dropout functions. For example, transaction service provider system 102 may apply the multiply function to an output of a dropout function that was generated based on the output from the Sigmoid activation function and the output of the dropout function that was generated based on the output from the Tan h activation function. In some non-limiting embodiments, transaction service provider system 102 may determine an output of the multiply function based on providing the output of the Sigmoid activation function and the output of a dropout function that was generated based on the output of the Tan h activation function to the multiply function.

In some non-limiting embodiments, transaction service provider system 102 may provide the output of the multiply function as an input to a 1×1 convolution layer. For example, transaction service provider system 102 may provide the output of the multiply function as the input to a 1×1 convolution layer to determine an output of the 1×1 convolution layer. In some non-limiting embodiments, the output of the 1×1 convolution layer may include an account dormancy label for the transaction (e.g., a label indicating that the account involved in the transaction is in an account in a normal state, an account in a pre-dormancy state, and/or an account in a dormancy state).

As shown by reference number 540 in FIG. 5B, transaction service provider system 102 may provide the output of second residual processing block 406 as an input to third residual processing block 408 and concatenate function block 412. In some non-limiting embodiments, transaction service provider system 102 may provide an output of a 1×1 convolution layer as input to a concatenate function. For example, transaction service provider system 102 may provide an output of a 1×1 convolution layer as input to concatenate function block 412 to determine an output of the concatenate function. In some non-limiting embodiments, the output of the 1×1 convolution layer may include an account dormancy label of the account of the customer (e.g., a first account dormancy label that includes an indication of an active state of the account of the customer, a second account dormancy label that includes an indication of a pre-dormancy state of the account of the customer, or a third account dormancy label that includes an indication of a dormancy state of the account of the customer).

As shown by reference number 550 in FIG. 5C, transaction service provider system 102 may generate an output of third residual processing block 408. For example, transaction service provider system 102 may provide an input to third residual processing block 406. As shown in FIG. 5C, the input to third residual processing block 408 may include a feature vector and the feature vector may include an array of values associated with the plurality of transactions T1-T9 and the output of second residual processing block 408 (e.g., a label that is an account dormancy label included in the output of second residual processing block 406). The feature vector may be the same feature vector as the feature vector provided as the input to first residual processing block 404 and second residual processing block 406. Transaction service provider system 102 may provide the feature vector as an input to a 1D dilated convolution layer with a time dilation factor equal to 2² (e.g., 4) and transaction service provider system 102 may generate an output of the 1D dilated convolution layer. Transaction service provider system 102 may scan a filter of the 1D dilated convolution layer over the positions of the array of the feature vector based on the time dilation factor. For example, transaction service provider system 102 may scan the filter of the 1D dilated convolution layer over the plurality of features associated with transactions T4 and T8, while skipping the plurality of features associated with transactions T1, T2, T3, T5, T6, T7, and T9. In some non-limiting embodiments, transaction service provider system 102 may apply a weight normalization function to the output of the 1D dilated convolution layer. For example, transaction service provider system 102 may apply the weight normalization function to the output of the 1D dilated convolution layer to transform one or more values of the output of the 1D dilated convolution layer into a value that is within a predetermined range (e.g., a range between 0 and 1, a range between −1 and 1, and/or the like). In some non-limiting embodiments, transaction service provider system 102 may apply a Sigmoid activation function to an output of the weight normalization function. For example, transaction service provider system 102 may apply the Sigmoid activation function to the output of the weight normalization function to transform one or more values of the output of the weight normalization function to a value between 0 and 1. In some non-limiting embodiments, transaction service provider system 102 may determine an output of the Sigmoid activation function based on providing the output of the weight normalization function to the Sigmoid activation function.

In some non-limiting embodiments, transaction service provider system 102 may apply a Tan h function to the output of the weight normalization function. For example, transaction service provider system 102 may apply the Tan h activation function to the output of the weight normalization function to transform one or more values of the output of the weight normalization function to a value between −1 and 1. In some non-limiting embodiments, transaction service provider system 102 may determine an output of the Tan h activation function based on providing the output of the weight normalization function to the Tan h activation function.

In some non-limiting embodiments, transaction service provider system 102 may apply a dropout function to an output of a Sigmoid activation function. For example, transaction service provider system 102 may apply the dropout function to the output of the Sigmoid activation function to transform one or more values of the output of the Sigmoid activation function. In some non-limiting embodiments, transaction service provider system 102 may determine an output of the dropout function based on providing the output of the Sigmoid activation function to the dropout function.

In some non-limiting embodiments, transaction service provider system 102 may apply a multiply function to an output of one or more dropout functions. For example, transaction service provider system 102 may apply the multiply function to an output of a dropout function that was generated based on the output from the Sigmoid activation function and the output of the dropout function that was generated based on the output from the Tan h activation function. In some non-limiting embodiments, transaction service provider system 102 may determine an output of the multiply function based on providing the output of the Sigmoid activation function and the output of a dropout function that was generated based on the output of the Tan h activation function to the multiply function.

In some non-limiting embodiments, transaction service provider system 102 may provide the output of the multiply function as an input to a 1×1 convolution layer. For example, transaction service provider system 102 may provide the output of the multiply function as the input to a 1×1 convolution layer to determine an output of the 1×1 convolution layer. In some non-limiting embodiments, the output of the 1×1 convolution layer may include an account dormancy label for the transaction (e.g., a label indicating that the account involved in the transaction is in an account in a normal state, an account in a pre-dormancy state, and/or an account in a dormancy state).

As shown by reference number 560 in FIG. 5C, transaction service provider system 102 may provide the output of third residual processing block 408 as an input to fourth residual processing block 410 and concatenate function block 412. In some non-limiting embodiments, transaction service provider system 102 may provide the output of the 1×1 convolution layer as input to a concatenate function. For example, transaction service provider system 102 may provide the output of the 1×1 convolution layer as input to concatenate function block 412 to determine an output of the concatenate function. In some non-limiting embodiments, the output of the 1×1 convolution layer may include an account dormancy label of the account of the customer (e.g., a first account dormancy label that includes an indication of an active state of the account of the customer, a second account dormancy label that includes an indication of a pre-dormancy state of the account of the customer, or a third account dormancy label that includes an indication of a dormancy state of the account of the customer).

As shown by reference number 570 in FIG. 5D, transaction service provider system 102 may generate an output of fourth residual processing block 410. For example, transaction service provider system 102 may provide an input to fourth residual processing block 410. As shown in FIG. 5D, the input to fourth residual processing block 410 may include a feature vector and the feature vector may include an array of values associated with the plurality of transactions T1-T9 and the output of third residual processing block 408 (e.g., a label that is an account dormancy label included in the output of third residual processing block 408). The feature vector may be the same feature vector as the feature vector provided as the input to first residual processing block 404, second residual processing block 406, and third residual processing block 408. Transaction service provider system 102 may provide the feature vector as an input to a 1D dilated convolution layer with a time dilation factor equal to 2⁴ (e.g., 16) and transaction service provider system 102 may generate an output of the 1D dilated convolution layer. Transaction service provider system 102 may scan a filter of the 1D dilated convolution layer over the positions of the array of the feature vector based on the time dilation factor. For example, transaction service provider system 102 may scan the filter of the 1D dilated convolution layer over the plurality of features associated with transaction T8, while skipping the plurality of features associated with transactions T1, T2, T3, T4, T5, T6, T7, and T9. In some non-limiting embodiments, transaction service provider system 102 may apply a weight normalization function to the output of the 1D dilated convolution layer. For example, transaction service provider system 102 may apply the weight normalization function to the output of the 1D dilated convolution layer to transform one or more values of the output of the 1D dilated convolution layer into a value that is within a predetermined range (e.g., a range between 0 and 1, a range between −1 and 1, and/or the like). In some non-limiting embodiments, transaction service provider system 102 may apply a Sigmoid activation function to an output of the weight normalization function. For example, transaction service provider system 102 may apply the Sigmoid activation function to the output of the weight normalization function to transform one or more values of the output of the weight normalization function to a value between 0 and 1. In some non-limiting embodiments, transaction service provider system 102 may determine an output of the Sigmoid activation function based on providing the output of the weight normalization function to the Sigmoid activation function.

In some non-limiting embodiments, transaction service provider system 102 may apply a Tan h function to the output of the weight normalization function. For example, transaction service provider system 102 may apply the Tan h activation function to the output of the weight normalization function to transform one or more values of the output of the weight normalization function to a value between −1 and 1. In some non-limiting embodiments, transaction service provider system 102 may determine an output of the Tan h activation function based on providing the output of the weight normalization function to the Tan h activation function.

In some non-limiting embodiments, transaction service provider system 102 may apply a dropout function to an output of a Sigmoid activation function. For example, transaction service provider system 102 may apply the dropout function to the output of the Sigmoid activation function to transform one or more values of the output of the Sigmoid activation function. In some non-limiting embodiments, transaction service provider system 102 may determine an output of the dropout function based on providing the output of the Sigmoid activation function to the dropout function.

In some non-limiting embodiments, transaction service provider system 102 may apply a multiply function to an output of one or more dropout functions. For example, transaction service provider system 102 may apply the multiply function to an output of a dropout function that was generated based on the output from the Sigmoid activation function and the output of the dropout function that was generated based on the output from the Tan h activation function. In some non-limiting embodiments, transaction service provider system 102 may determine an output of the multiply function based on providing the output of the Sigmoid activation function and the output of a dropout function that was generated based on the output of the Tan h activation function to the multiply function.

In some non-limiting embodiments, transaction service provider system 102 may provide the output of the multiply function as an input to a 1×1 convolution layer. For example, transaction service provider system 102 may provide the output of the multiply function as the input to a 1×1 convolution layer to determine an output of the 1×1 convolution layer. In some non-limiting embodiments, the output of the 1×1 convolution layer may include an account dormancy label for the transaction (e.g., a label indicating that the account involved in the transaction is in an account in a normal state, an account in a pre-dormancy state, and/or an account in a dormancy state).

As shown by reference number 580 in FIG. 5D, transaction service provider system 102 may provide the output of fourth residual processing block 410 as an input to concatenate function block 412. In some non-limiting embodiments, transaction service provider system 102 may provide the output of the 1×1 convolution layer as input to a concatenate function. For example, transaction service provider system 102 may provide the output of the 1×1 convolution layer as input to concatenate function block 412 to determine an output of the concatenate function. In some non-limiting embodiments, the output of the 1×1 convolution layer may include an account dormancy label of the account of the customer (e.g., a first account dormancy label that includes an indication of an active state of the account of the customer, a second account dormancy label that includes an indication of a pre-dormancy state of the account of the customer, or a third account dormancy label that includes an indication of a dormancy state of the account of the customer).

As shown by reference number 590 in FIG. 5E, transaction service provider system 102 may determine an account dormancy label for the account of the customer. For example, transaction service provider system 102 may generate an output of the concatenate function block 412 based on the output of the first residual processing block 404, the output of the second residual processing block 406, the output of the third residual processing block 408, and the output of the fourth residual processing block 410. In some non-limiting embodiments, the output of concatenate function block 412 may include an embedding vector associated with the output of the first residual processing block 404, the output of the second residual processing block 406, the output of the third residual processing block 408, and the output of the fourth residual processing block 410. For example, the output of the concatenate function block may include an embedding vector that includes the output of the first residual processing block 404, the output of the second residual processing block 406, the output of the third residual processing block 408, and the output of the fourth residual processing block 410 concatenated together.

In some non-limiting embodiments, transaction service provider system 102 may provide the output of the concatenate function block 412 as an input to first dense layer 414 that includes 512 nodes. In some non-limiting embodiments, transaction service provider system 102 may provide the output of first dense layer 414 to second dense layer 416. In some non-limiting embodiments, transaction service provider system 102 may provide an output of second dense layer 416 to softmax layer 418. In some non-limiting embodiments, transaction service provider system 102 may generate softmax layer output 420 by applying softmax layer 418 to the output of second dense layer 416. In some non-limiting embodiments, softmax layer 418 may include a softmax function, as described herein.

In some non-limiting embodiments, softmax layer output 420 may include an account dormancy label of an account of the customer (e.g., a first account dormancy label that includes an indication of an active state of the account of the customer, a second account dormancy label that includes an indication of a pre-dormancy state of the account of the customer, or a third account dormancy label that includes an indication of a dormancy state of the account of the customer). In some non-limiting embodiments, softmax layer output 420 may include data associated with an account dormancy label as described herein.

Although the above methods, systems, and computer program products have been described in detail for the purpose of illustration based on what is currently considered to be the most practical and preferred embodiments or aspects, it is to be understood that such detail is solely for that purpose and that the present disclosure is not limited to the described embodiments or aspects but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method for determining a customer dormancy profile comprising:
receiving, with at least one processor, transaction data associated with a plurality of payment transactions conducted using an account of an account holder;
generating, with at least one processor, an output of a first residual processing block based on the transaction data associated with the plurality of payment transactions;
providing, with at least one processor, the output of the first residual processing block to a concatenate function block and to a second residual processing block;
generating, with at least one processor, an output of the second residual processing block based on the output of the first residual processing block;
generating, with at least one processor, an output of the concatenate function block based on the output of the first residual processing block and the output of the second residual processing block, wherein the output of the concatenate function block comprises an embedding vector; and
determining, with at least one processor, an account dormancy label based on the output of the concatenate function block.

2. The computer-implemented method of claim 1, wherein generating the output of the first residual processing block comprises:
applying a one-dimensional dilated convolution layer to the transaction data associated with the plurality of payment transactions to generate a dilated convolution layer output, wherein the one-dimensional dilated convolution layer comprises a dilation factor;
applying a weight normalization function to the dilated convolution layer output to generate an output of the weight normalization function;
applying a Tan h activation function to the output of the weight normalization function to generate an output of the Tan h activation function; and
applying a Sigmoid activation function to the output of the weight normalization function to generate an output of the Sigmoid activation function;
wherein the output of the first residual processing block is based on the output of the Tan h activation function and the output of the Sigmoid activation function.

3. The computer-implemented method of claim 2, further comprising:
generating the dilated convolution layer output based on applying the one-dimensional dilated convolution layer to the transaction data associated with the plurality of payment transactions.

4. The computer-implemented method of claim 2, further comprising:
applying a dropout function to the output of the Tan h activation function to generate a first output of the dropout function;
applying the dropout function to the output of the Sigmoid activation function to generate a second output of the dropout function;
applying a multiply function to the first output of the dropout function and the second output of the dropout function to generate an output of the multiply function; and
applying a one-by-one convolution layer to the output of the multiply function;
wherein the output of the first residual processing block comprises an output of the one-by-one convolution layer based on the output of the multiply function.

5. The computer-implemented method of claim 2, wherein the dilation factor of the one-dimensional dilated convolution layer is equal to one.

6. The computer-implemented method of claim 1, wherein generating the output of the second residual processing block comprises:
applying a one-dimensional dilated convolution layer to the output of the first residual processing block to generate a dilated convolution layer output, wherein the one-dimensional dilated convolution layer comprises a dilation factor;
applying a weight normalization function to the dilated convolution layer output to generate an output of the weight normalization function;
applying a Tan h activation function to the output of the weight normalization function to generate an output of the Tan h activation function; and
applying a Sigmoid activation function to the output of the weight normalization function to generate an output of the Sigmoid activation function;
wherein the output of the first residual processing block is based on the output of the Tan h activation function and the output of the Sigmoid activation function.

7. The computer-implemented method of claim 1, wherein determining the account dormancy label based on the output of the concatenate function block comprises:
providing the output of the concatenate function block to one or more dense layers;
generating an output of the one or more dense layers based on the output of the concatenate function block;
providing the output of the one or more dense layers to a softmax activation function;
generating an output of the softmax activation function; and
applying the account dormancy label to the account of the account holder based on the output of the softmax activation function.

8. A system for determining a customer dormancy profile comprising:
at least one processor programmed or configured to:
receive transaction data associated with a plurality of payment transactions conducted using an account of an account holder;
generate an output of a first residual processing block based on the transaction data associated with the plurality of payment transactions;
provide the output of the first residual processing block to a concatenate function block and to a second residual processing block;
generate an output of the second residual processing block based on the output of the first residual processing block;
generate an output of the concatenate function block based on the output of the first residual processing block and the output of the second residual processing block; and
determine an account dormancy label based on the output of the concatenate function block.

9. The system of claim 8, wherein when generating the output of the first residual processing block, the at least one processor is programmed or configured to:
apply a one-dimensional dilated convolution layer to the transaction data associated with the plurality of payment transactions to generate a dilated convolution layer output, wherein the one-dimensional dilated convolution layer comprises a dilation factor;
apply a weight normalization function to the dilated convolution layer output to generate an output of the weight normalization function;
apply a Tan h activation function to the output of the weight normalization function to generate an output of the Tan h activation function; and
apply a Sigmoid activation function to the output of the weight normalization function to generate an output of the Sigmoid activation function;
wherein the output of the first residual processing block is based on the output of the Tan h activation function and the output of the Sigmoid activation function.

10. The system of claim 9, wherein the at least one processor is further programmed or configured to:
generate the dilated convolution layer output based on applying a one-dimensional dilated convolution layer to the transaction data associated with the plurality of payment transactions.

11. The system of claim 9, wherein the at least one processor is further programmed or configured to:
apply a dropout function to the output of the Tan h activation function to generate a first output of the dropout function;
apply the dropout function to the output of the Sigmoid activation function to generate a second output of the dropout function;
apply a multiply function to the first output of the dropout function and the second output of the dropout function to generate an output of the multiply function; and
apply a one-by-one convolution layer to the output of the multiply function; and
wherein the output of the first residual processing block comprises an output of the one-by-one convolution layer based on the output of the multiply function.

12. The system of claim 9, wherein the dilation factor of the one-dimensional dilated convolution layer is equal to one.

13. The system of claim 8, wherein, when generating the output of the second residual processing block, the at least one processor is programmed or configured to:
apply a one-dimensional dilated convolution layer to the output of the first residual processing block to generate a dilated convolution layer output, wherein the one-dimensional dilated convolution layer comprises a dilation factor;
apply a weight normalization function to the dilated convolution layer output to generate an output of the weight normalization function;
apply a Tan h activation function to the output of the weight normalization function to generate an output of the Tan h activation function; and
apply a Sigmoid activation function to the output of the weight normalization function to generate an output of the Sigmoid activation function;
wherein the output of the first residual processing block is based on the output of the Tan h activation function and the output of the Sigmoid activation function.

14. The system of claim 8, wherein, when determining the account dormancy label based on the output of the concatenate function block, the at least one processor is programmed or configured to:
provide the output of the concatenate function block to one or more dense layers;
generate an output of the one or more dense layers based on the output of the concatenate function block;
provide the output of the one or more dense layers to a softmax activation function;
generate an output of the softmax activation function; and
apply the account dormancy label to the account of the account holder based on the output of the softmax activation function.

15. A computer program product for determining a customer dormancy profile, the computer program product comprising at least one non-transitory computer-readable medium including one or more instructions that, when executed by at least one processor, cause the at least one processor to:
receive transaction data associated with a plurality of payment transactions conducted using an account of an account holder;
generate an output of a first residual processing block based on the transaction data associated with the plurality of payment transactions;
provide the output of the first residual processing block to a concatenate function block and to a second residual processing block;
generate an output of the second residual processing block based on the output of the first residual processing block;
generate an output of the concatenate function block based on the output of the first residual processing block and the output of the second residual processing block; and
determine an account dormancy label.

16. The computer-implemented method of claim 15, wherein the one or more instructions that cause the at least one processor to generate the output of the first residual processing block cause the at least one processor to:
apply a one-dimensional dilated convolution layer to the transaction data associated with the plurality of payment transactions to generate a dilated convolution layer output, wherein the one-dimensional dilated convolution layer comprises a dilation factor;
apply a weight normalization function to the dilated convolution layer output to generate an output of the weight normalization function;
apply a Tan h activation function to the output of the weight normalization function to generate an output of the Tan h activation function; and
apply a Sigmoid activation function to the output of the weight normalization function to generate an output of the Sigmoid activation function;
wherein the output of the first residual processing block is based on the output of the Tan h activation function and the output of the Sigmoid activation function.

17. The computer program product of claim 16, wherein the one or more instructions further cause the at least one processor to:
generate the dilated convolution layer output based on applying a one-dimensional dilated convolution layer to the transaction data associated with the plurality of payment transactions.

18. The computer program product of claim 16, wherein the one or more instructions further cause the at least one processor to:
apply a dropout function to the output of the Tan h activation function to generate a first output of the dropout function;
apply the dropout function to the output of the Sigmoid activation function to generate a second output of the dropout function;
apply a multiply function to the first output of the dropout function and the second output of the dropout function to generate an output of the multiply function; and
apply a one-by-one convolution layer to the output of the multiply function; and
wherein the output of the first residual processing block comprises an output of the one-by-one convolution layer based on the output of the multiply function.

19. The computer program product of claim 16, wherein the dilation factor of the one-dimensional dilated convolution layer is equal to one.

20. The computer program product of claim 15, wherein the one or more instructions that cause the at least one process to generate the output of the second residual processing block cause the at least one processor to:
apply a one-dimensional dilated convolution layer to the output of the first residual processing block to generate a dilated convolution layer output, wherein the one-dimensional dilated convolution layer comprises a dilation factor;
apply a weight normalization function to the dilated convolution layer output to generate an output of the weight normalization function;
apply a Tan h activation function to the output of the weight normalization function to generate an output of the Tan h activation function; and
apply a Sigmoid activation function to the output of the weight normalization function to generate an output of the Sigmoid activation function;
wherein the output of the first residual processing block is based on the output of the Tan h activation function and the output of the Sigmoid activation function.
